(19) United States
(12) Patent Application Publication
(10) Pub. No.: US 2016/0035447 A1
(43) Pub. Date: Feb. 4, 2016

(54) Integrated System for Forming and Transporting Packaging Assemblies, and the Assembly, Filling and Disassembly Stations Thereof

(71) Applicant: COCKERILL MAINTENANCE & INGENIERIE S.A., Seraing (BE)

(72) Inventors: Philippe Fontaine, Plainevaux (BE); Aldo Gressani, Grâce-Hollogne (BE)

(21) Appl. No.: 14/775,304

(22) PCT Filed: Mar. 12, 2014
(86) PCT No.: PCT/EP2014/054769

§ 371 Date: Sep. 11, 2015

(30) Foreign Application Priority Data
Mar. 13, 2013 (BE) BE2013/0160

(51) Int. Cl. G21F 5/008; G21F 5/06; G21C 19/10

(52) U.S. Cl. CPC G21F 5/008; G21C 19/10; G21F 5/06

(57) ABSTRACT

The invention relates to an assembly consisting of a plurality of packaging bottles (1) for conditioning, storing and transporting radioactive bars or tubes, hereinafter called fagot assembly (2), wherein: said bottles (1) are identical and interchangeable; and said bottles are attached to each other in order to form a fagot or a bundle (2), by means of quick-fastening means (3), said fagot (2) comprising N bottles, N≧2; characterised in that said bottles (1) are formed from steel and are thicker at one of the two ends thereof, over a certain length.

### SUBJECT-MATTER OF THE INVENTION

The present invention relates to the conditioning, storage and transport of radioactive waste in packaging meeting international standards for transporting radioactive materials (fuel, contaminated and radioactive materials).

The invention is mainly designed for the nuclear power plant sector in the civilian field sector, preferably of the light water type, and still more preferably of the pressurized water reactor (PWR) type, in particular regarding maintaining or dismantling reformed guide tubes for control cluster rods (RGTCCR).

The invention more particularly relates to the activities of conditioning, transporting and warehousing RGTCCRs.

### BACKGROUND OF THE INVENTION AND STATE OF THE ART

In pressurized or boiling water reactor nuclear power plants, the power of the reactor is modulated by moving, in the core of the reactor, bars absorbing the neutron flux generated by nuclear fission. These bars are assembled in control clusters that are inserted into fuel assemblies. The latter include hollow slots in a number corresponding to the number of bars per cluster. These hollow slots are occupied by guide tubes of the control clusters that may deteriorate over time (wear after friction during use, deformation due to high temperatures).

FIG. 1 shows a diagrammatic sectional view of a PWR tank with a minimum power of 900 MW. The internal equipment of the tank, excluding nuclear fuel, in particular performs the support and lateral maintenance functions of the fuel assemblies and the guiding functions for the control clusters and the instrumentation. The guide tubes 12 are positioned at the level of the upper inner equipment through an upper support plate or support cap 11 up to an upper core plate 13, the two plates 11, 13 being separated by tubular spacers 15.

Mainly following the Fukushima nuclear accident in 2011, many countries revised their policy related to the use of nuclear energy and considerably increased their requirements with respect to nuclear safety. Currently, specifically in the field of nuclear maintenance, an increased need has been observed, both through these new laws and the aging of the existing power plants, to replace and therefore condition and transport, quickly and reliably, a large number of reformed guide tubes for control cluster rods (RGTCCR) from the reactor, pool or warehousing packaging, etc. of nuclear power plant units.

To date, damaged RGTCCRs have been replaced from time to time, at the same time as the nuclear fuel. Because they are subject to an intense neutron flux during use, these RGTCCRs removed from the core of the reactor have a radioactivity level that may be dangerous for the health of the operator (resulting from the presence of ⁶⁰Co, which emits highly energizing gamma rays for instance). To date, several tens of tubes could thus be confined in the same type of packaging, from the conditioning in the zone to the storage or handling location, but always within the perimeter of the power plant.

Today, it is desired to allow the conditioning of these RGTCCRs in the reactor building, within a limited space and with a limited handling capacity, as well as their transport, in an approved, safe, reliable, cost-effective and quick manner.

The packaging intended for transporting radioactive materials must obey standards set by the Regulation of the International Atomic Energy Agency (IAEA). Thus, the Type A packaging is a type of certified packaging used for relatively limited, but significant quantities of radioactive products. It is designed to withstand accidents. It is subject to tests simulating the transfer conditions. Its compliance with the IAEA rules is also demonstrated by calculation. The Type B packaging is a type of certified packaging used to transport quantities of highly radioactive materials. It is designed to withstand defined accident conditions and is thus subject to tests that simulate not only common handling and transport conditions, but also accident conditions (for example, freefall, submersion, crushing, flattening, fire resistance).

The stakes to be met are as follows:
ensuring the removal of the RGTCCRs outside the power plant, preferably with Type A packaging. Thus, if one wishes to transport several RGTCCRs in the same package, this package must necessarily be of Type B. To design and obtain the approval for Type B packaging, it takes several years in light of the complex regulatory requirements in force for this packaging;
eliminating, or at least reducing, the temporary storage time for RGTCCRs in the pools;
reducing or eliminating the warehousing time for RGTCCRs in the power plant;
decreasing the time of the operations in the zone;
increasing the safety of the operations within and outside the zone;
decreasing the cost of the operations and the downtime of the power plant;
providing radiation protection for the transported parcels;
removing RGTCCRs from the power plant, either directly after their removal from the reactor, or optionally from their warehousing in the pool, or in warehousing packaging, not designed for transport, so as to have them undergo an appropriate treatment or storage in or outside the power plant and according to the laws in force.

The aforementioned needs are not currently met. In fact, to date, the need identified above has not been considerable, or has even been almost marginal.

The solution in the state of the art is to store these RGTCCRs in a pool or place them in a power plant in warehousing packaging, which is not designed for transport.

This packaging provides radiation protection inasmuch as there is no continuous and close human presence.

Other existing solutions are known, for example the ongoing development of Type B packaging that may contain several RGTCCRs, for example five RGTCCRs. Another option for packaging radioactive material from the pool is to submerge the packaging in the pool or place it next to the pool, filled with water, knowing that at the end of the operation, it is necessary to empty and dry it. Furthermore, if it has been submerged in the pool, it is necessary to decontaminate that packaging before moving it.

The flaws of the existing solutions are as follows:
limited capacities: the current types of packaging capable of and suitable for transporting radioactive waste, and their available quantity, cause problems of approval and logistics problems that are difficult to accept with respect to the environment (authorities, population, safety, etc.);
in case of accident during transport, risks are increased when there is a concentration of radioactive waste in a single package;
the payload and the authorized dimensions on the road limit the quantities of materials that can be transported;
the operations related to the filling of Type B packaging require increased precautions with respect to Type A;
Type B packaging requires special convoy;
the current warehousing packaging is not designed for transport;
in case of long-term warehousing in a power plant, an additional protective tower is necessary around the warehousing packaging, if human beings are present nearby.

The limitations of these solutions are often related to their weight and volume for road transport.

Existing solutions are also known in other fields for similar needs, for example the assembly of bottles (rack) for road transport and rail transport of gaseous and/or hazardous products. If necessary, exceptional transport is used (dimensions increased based on traffic laws).

Currently, there is no system that allows the simultaneous conditioning, mass removal outside the reactor building and the transport of RGTCCRs under safety, duration and cost conditions compatible with the technical, regulatory and economic requirements of the market and that is socially acceptable, whereas this need has recently appeared because it is related to extending the lifetime of PWR units.

In general, containers designed for the storage, handling, or even transport of hazardous materials, such as radioactive materials, in particular spent fuel or radioactive waste from nuclear power plants, are known. These containers generally assume the form of bottles, canisters or barrels with a body, a bottom and one or two covers, the closing of which may be secured. The container may be made up of one or more shells, for example an outer shell and an inner shell (see for example EP2172944, WO2009/81078, WO2008/153478, EP1978530, WO2008/97381, EP2059930, U.S. Pat. No. 5,431,295, EP186487).

In some cases, a storage device has been provided to store a certain quantity of barrels: a lower plate and an upper plate connected by guide tubes, formed from steel, the upper part being connected to a guide sleeve, so as to stack and secure the barrels on one another (CN201134275 U), a cylindrical container made from a bituminous material making it possible to stack individual barrels within it, the space between the barrels being filled with polyurethane foam, in order to prevent steam penetration as well as leaks and environmentally harmful effects (U.S. Pat. No. 3,935,467).

Packaging assemblies are also known, for example a maritime or pallet-type container comprising support and inner partition structures for the transport and storage of radioactive products (EP2201577, KR20050072025).

In LT201000049, the containers are provided with protective parts and with holes and hooks to allow handling and road transport, in the vertical position.

Document US2005/0117687 discloses an apparatus and methods for the storage or transport of spent nuclear fuel. In one embodiment, a container for storing spent nuclear fuel comprises a plurality of elongated tubes that receive spent nuclear fuel rods. Each tube includes four side walls and four corners defining a rectangular cross-section. The plurality of tubes is positioned in an alternated pattern. A fastening means fastens the plurality of tubes to one another at the corners so that two adjacent side walls of adjacent tubes are substantially aligned.

Document JP2001141882 aims to provide a concrete storage container capable of storing radioactive materials completely safely, stably and for a long period of time without having to receive major vibrations, etc., as well as a storage tank unit provided with a plurality of concrete storage containers. To that end, an annular fastening belt is provided on the peripheral surface of the container body of a concrete barrel. The fastening belt includes a plurality of fastening parts separated from one another along the circumferential direction. Each fastening part is designed to be fastened to a connecting element. With the fastening band and the connecting elements, a plurality of concrete barrels are connected to one another and form a storage tank unit.

Document U.S. Pat. No. 4,65,2422 discloses a support device for an element formed by at least one part of an elongated nuclear reactor fuel element, the support device having an elongated receiving sleeve mounted vertically on a base surface and having an upper end formed with an opening and a maintaining device situated at the upper end of the sleeve to suspend the element inside the receiving sleeve. The support device comprises a removable cover closing the opening at the upper end of the receiving sleeve, the maintaining device being fastened to the inside of the cover.

### AIMS OF THE INVENTION The present invention aims to propose a new conditioning and transport system for RGTCCRs in a group of Type A packages.

The invention also aims to allow the handling and transport of RGTCCRs under regulatory radiation protection conditions for operators and allowing a stop time of the reactor as short as possible. The invention also aims to allow road transport of RGTCCRs under ordinary conditions, without requiring a special convoy.

### PRIMARY FEATURES OF THE INVENTION

A first aspect of the present invention relates to an assembly consisting of a plurality of packaging bottles intended for conditioning, storing and transporting radioactive bars or tubes, hereinafter called fagot assembly, wherein:
said bottles are identical and interchangeable;
and said bottles are attached to each other to form a fagot or a bundle by means of quick-fastening means, said fagot comprising N bottles, N≧2;
   characterized in that said bottles are formed from steel and are thicker at one of the two ends thereof, over a certain length.

Preferably, the fagot assembly is modular and has a variable geometry, i.e., it can be subdivided or dimensioned in smaller subassemblies, still using the same fastening means (3).

Also preferably, each of said bottles is a package corresponding to the Type A certification of the IAEA Regulation for the transport of radioactive materials, and the fagot assembly also corresponds to said Type A certification.

A second aspect of the invention relates to the use of a fagot assembly as described above, for conditioning, storing and transporting reformed guide tubes for control cluster rods coming from pressurized or boiling water nuclear reactors.

A third aspect of the invention relates to a handling installation for filling Type A packaging bottles with radioactive bars or tubes in the building of a nuclear reactor, said bottles forming a fagot assembly as described above, said installation being integrated into the fagot assembly so that the ground footprint of that integrated installation is limited to the dimensions of the fagot assembly.

Preferably, the fagot assembly is topped by walkways and equipped with ladders and lifting means.

A fourth aspect of the invention relates to an installation for the assembly and disassembly with quick-fastening means of Type A packaging bottles in one or more fagot assemblies as well as their subassemblies, as described above, outside the building of a nuclear reactor.

A fifth aspect of the invention relates to a packaging, storage and transport method for reformed guide tubes for control cluster rods coming from a nuclear reactor, by means of packaging bottles that can be arranged in fagot assemblies as described above, characterized by the following steps:
Type A packaging bottles, arranged vertically, are used to form a fagot assembly in an assembly/disassembly station, situated outside the reactor building, the assembly of the packaging bottles being done using the quick fastening means;
the fagot assembly thus formed is inserted in the reactor building, positioned vertically in a handling station;
for each packaging bottle of the fagot assembly, the bottle is opened, a reformed guide tube for control cluster rods is inserted, and the bottle is closed;
the fagot assembly is removed from the reactor building and the fagot assembly is once again placed in the assembly/disassembly station, where subassemblies of the fagot assembly are formed, these subassemblies being smaller than the latter and compatible with road transport under standard regulations, excluding special convoys;
the subassemblies are tilted to the horizontal position and fastened to a heavy goods vehicle.

According to preferred embodiments of the method, the method according to the invention comprises one or more of the following features:
the step for inserting the reformed guide tube for control cluster rods into its packaging bottle is carried out outside the pool, dry or underwater, using a heavy hood to remove the guide tube from the nuclear reactor;
the step for inserting the reformed guide tube for control cluster rods into its packaging bottle is carried out in the pool, i.e., underwater in the reactor, an additional operation for drying the bottles being provided;
the transfer of the fagot assembly from the outside to the reactor building and vice versa is done using an equipment access hatch, the fagot assembly being in a vertical or horizontal position for the transfer.

### BRIEF DESCRIPTION OF THE FIGURES

FIG. 1, already mentioned, diagrammatically shows the upper inner equipment of a PWR nuclear reactor tank with a power greater than or equal to 900 MW (according to EDF documentation).

FIG. 2A shows a perspective view of a fagot assembly of Type A packages according to a first embodiment of the invention.

FIG. 2B shows two perspective views of a fagot assembly of Type A packages according to a second embodiment of the present invention. The left view also shows one of the package and its content, a RGTCCR, in cross-section.

FIG. 2C shows an elevation view and a plan view of the fagot assembly according to the embodiment of FIG. 2B.

FIG. 3 shows a perspective view of an example of an assembly and disassembly station for Type A packaging for two fagot assemblies, according to the present invention.

FIG. 4 shows a perspective view of an example of a filling station inside the reactor building for fagot assemblies of Type A packages, according to the present invention.

FIG. 5 shows a perspective view, an elevation view and a plan view of an example of the loading of Type A packages into subassemblies of three packages, on a heavy goods vehicle of the semitrailer type, according to the present invention.

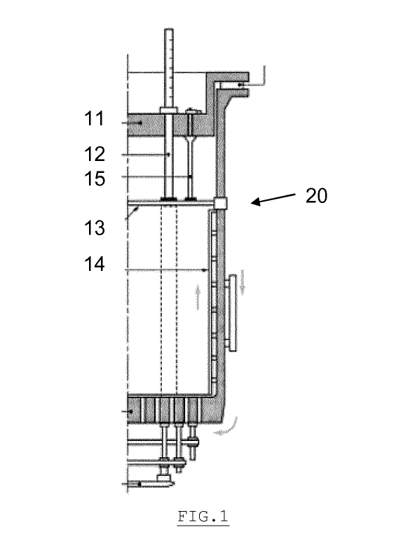

### DETAILED DESCRIPTION OF THE INVENTION

Following the identification of needs not met by the state of the art, the Applicant was led to design a system made up of Type A packages, a fagot assembly of several of those packages, a filling station in a reactor building, an assembly/disassembly station for Type A packaging, an assembly mode, specific tilting and transport devices intended for the transport, the warehousing and the unloading of this type of radioactive waste. A fagot or bundle refers to a set of individual packages, extending in all three dimensions, those packages each having an appropriate shape, for example the shape of an elongated can to contain a single irradiated tube. These packages are secured to one another.

The concept of Type A packaging in a fagot assembly makes it possible to:
limit the manipulations of radioactive waste and limit the spaces necessary for various operations;
perform several operations in parallel;
maximize the safety of operations (ALARA initiative);
minimize the times of the operations in the reactor building;
see to the evolution of the composition of the fagot assembly based on:
   the replacement needs of the RGTCCRs (the number of RGTCCRs to be conditioned may vary based on their condition and the decision by the power plant operator),
   the type of transport,
   the assembly, disassembly, filling zones for the fagot assembly,
   the storage or handling zone;
allow massive removal of the RGTCCRs and their conditioning directly from Type A packages suitable for transport. Packaging for warehousing in the power plant that is currently available is not approved for transport, but only for warehousing in the power plant;
fill Type A packages in the reactor building, outside or in the pool;
assemble/disassemble outside the reactor building, therefore outside the zone and thus in masked time.

The features and requirements of the invention are as follows:
an equivalent dose rate (EDR) of 2 mSv/h maximum in contact;
an identical system for all types of RGTCCRs of PWR unit;
the assembly of Type A packages so that the fagot assembly remains of Type A;
a filling installation inside the reactor building integrated into the fagot assembly;
an insertion of the RGTCCR in the package being done either dry or underwater. The package is closed, ensuring the confinement of the RGTCCR, before filling the following Type A package. The operation is repeated until the fagot assembly is completely filled;
a quick assembly and disassembly system for Type A packaging outside the reactor building;
the possibility of assembling a subassembly comprising an optimal number of Type A packages per fagot assembly based on local conditions and operating needs;
a ground footprint in the reactor building strictly limited to the dimensions of the fagot assembly;
dimensions of the fagot assembly compatible with the dimensions of the insertion device in the reactor building;
a composition of the fagot assembly suitable for the available lifting capacities.

Currently, there is no solution for this type of application using such Type A equipment.

The advantages are as follows:
easier compliance with the transport regulations related to this type of radioactive waste;
road transport on standard transport gauges;
easy adaptation to the available handling gears and transport units.

### DESCRIPTION OF PREFERRED EMBODIMENTS OF THE INVENTION

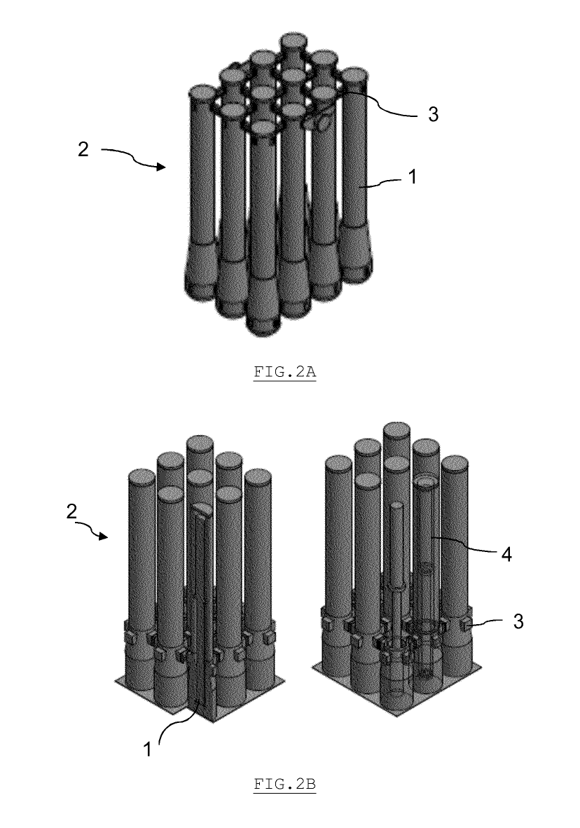

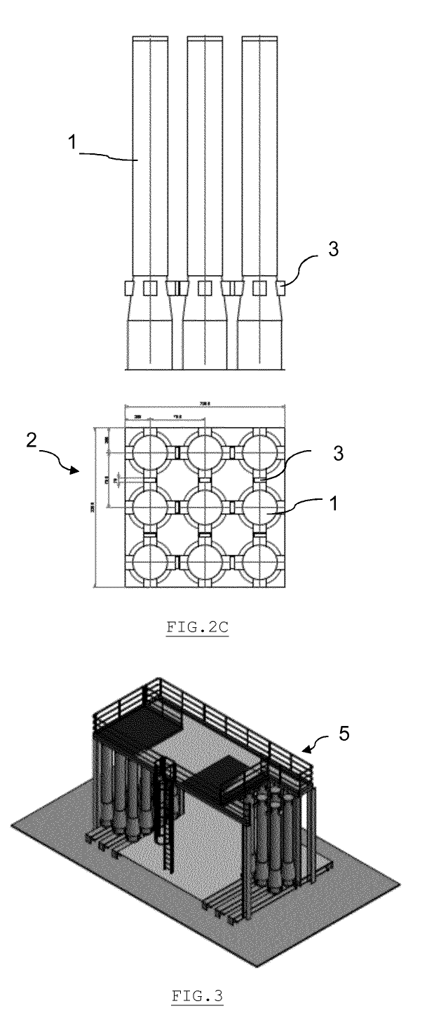

According to one preferred embodiment of the invention (FIGS. 2A, 2B, 2C), each Type A package 1 contains a single RGTCCR 4. It is designed to transfer radioactive products. All of the Type A packages 1 are identical and interchangeable. They will preferably assume the form of a can or elongated barrel, i.e., a cylinder with a bottom and a cover (or with two covers) for instance, the length of the cylinder being at least equal to the diameter of the bottom or the cover. These packages will preferably be formed from steel. In order to account for the fact that the end of the RGTCCR situated closest to the core of the reactor is more radioactive than the other end, the steel thickness will be greater at the first end (for example, 150 mm of steel versus 60 mm of steel). The packages are assembled in a fagot assembly 2. A fagot assembly 2 may be made up of two to N Type A packages 1 (N>2).

The Type A packages 1 and the fagot assembly 2 are designed to meet the legal requirements relative to radiation protection for transport. The assemblies are done by quick connection devices 3, per se known by those skilled in the art. The fagot assemblies 2 can be assembled/disassembled by unit packaging 1 or sub-groups or subassemblies of unit packaging 1: they are modular and have a variable geometry. The fagot assemblies 2 and any subassemblies are designed to be manipulated and filled vertically and to be tilted into a horizontal position using appropriate handling vehicles (not shown).

A fagot assembly with 12 packages for example has a total weight of less than 60 tons and may enter in the vertical position in the reactor building through the equipment access hatch (EAH) of all of the known PWR units; however, if necessary, it may enter in the horizontal position.

The filling of the fagot assemblies 2 is done in the vertical position, normally outside the pool, by removing the tubes one by one, preferably under a heavy hood. Nevertheless, it may also be done in the pool, if necessary.

The assembly and disassembly of the fagot assemblies 2 is done outside the reactor building on an assembly/disassembly station 5, for example normally provided for 2 workstations (FIG. 3). Appropriate lifting gears are used to that end (not shown).

After assembly, the fagot assemblies 2 of N Type A packages are introduced in the reactor building.

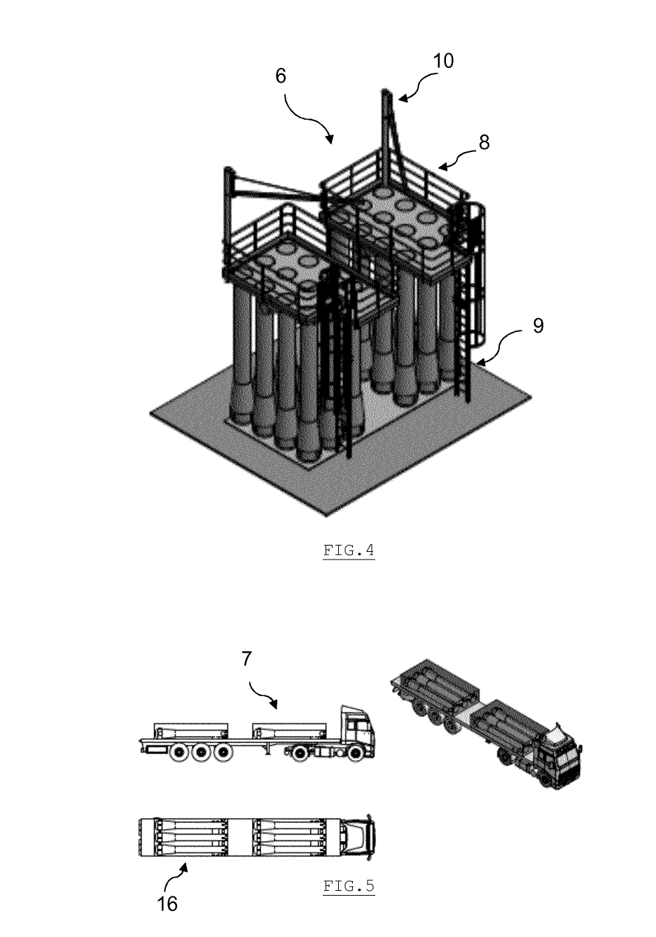

During the filling in the reactor building, each fagot assembly 2 is vertically integrated with a handling station 6 (FIG. 4). Each of the fagot assemblies 2 is then topped by walkways 8 and equipped with ladders 9 and lifting gears 10 (winches, spreaders, etc.) to allow the filling operations. The filling of each of the Type A packages 1 can be done dry or underwater, in the vertical position. However, the operating and drying times are drastically decreased with respect to underwater filling.

Each package belonging to the fagot assembly 2 is successively opened, filled with its RGTCCR 1 and then closed. The operation is repeated until all of the Type A packages 1 of the fagot assembly 2 are filled. The filled fagot assemblies 2 are then transferred outside the reactor building.

Once filled and transferred outside the reactor building, the fagot assemblies 2 are once again conveyed on the assembly/disassembly station 5 to be broken down there into subassemblies 16, for example of three assembled packages, suitable for standard road transport by heavy goods vehicle, for example of the semitrailer type 7 (FIG. 5). The subassemblies 16 tilted and attached to the semitrailer by appropriate lifting gears (not shown) are then ready for transport.

### LIST OF REFERENCE SYMBOLS

1 individual Type A packaging bottle
2 fagot assembly
3 quick connection
4 guide tube for control cluster rods
5 assembly/disassembly station
6 inner loading assembly inside the reactor building (handling station)
7 heavy goods vehicle
8 walkway
9 ladder
10 lifting gear
11 upper support plate
12 guide tube for control cluster rods
13 upper core plate
14 core shell
15 spacer
16 subassembly of packaging bottles
20 tank

1. An assembly consisting of a plurality of packaging bottles (1) intended for conditioning, storing and transporting radioactive bars or tubes, hereinafter called fagot assembly (2), wherein:
said bottles (1) are identical and interchangeable;
and said bottles (1) are attached to each other to form a fagot or a bundle (2), by means of quick-fastening means (3), said fagot (2) comprising N bottles, N≧2;
characterized in that said bottles (1) are formed from steel and are thicker at one of the two ends thereof, over a certain length.

2. The fagot assembly (2) according to claim 1, characterized in that it is modular and has a variable geometry, i.e., it can be subdivided or dimensioned in smaller subassemblies, still using the same fastening means (3).

3. The fagot assembly (2) according to claim 1, characterized in that each of said bottles (1) is a type of packaging corresponding to the Type A certification of the IAEA Regulation for the transport of radioactive materials, and the fagot assembly (2) also corresponds to said Type A certification.

4. A use of a fagot assembly (2) according to claim 1, for conditioning, storing and transporting reformed guide tubes for control cluster rods (4) coming from pressurized or boiling water nuclear reactors.

5. A handling installation (6) for filling Type A packaging bottles (1) with radioactive bars or tubes in the building of a nuclear reactor, said bottles (1) forming a fagot assembly (2) according to claim 1, said installation being integrated into the fagot assembly (2) so that the ground footprint of that integrated installation is limited to the dimensions of the fagot assembly (2).

6. The handling installation (6) according to claim 5, characterized in that the fagot assembly (2) is topped by walkways (8) and equipped with ladders (9) and lifting means (10).

7. An installation for the assembly and disassembly (5) with quick-fastening means (3) of Type A packaging bottles (1) in one or more fagot assemblies (2) as well as in their subassemblies, according to claim 1, outside the building of a nuclear reactor.

8. A conditioning, storage and transport method for reformed guide tubes for control cluster rods (4) coming from a nuclear reactor, by means of packaging bottles (1) that can be arranged in fagot assemblies (2) according to claim 1, characterized by the following steps:
Type A packaging bottles (1), arranged vertically, are used to form a fagot assembly (2) in an assembly/disassembly station (5), situated outside the reactor building, the assembly of the packaging bottles (1) being done using the quick-fastening means (3);
the fagot assembly (2) thus formed is inserted in the reactor building, positioned vertically in a handling station (6);
for each packaging bottle (1) of the fagot assembly (2), the bottle (1) is opened, a reformed guide tube for control cluster rods(4) is inserted, and the bottle (1) is closed;
the fagot assembly (2) is removed from the reactor building and the fagot assembly (2) is once again placed in the assembly/disassembly station (5), where subassemblies (16) of the fagot assembly (2) are formed, these subassemblies being smaller than the latter and compatible with road transport under standard regulations, excluding special convoy;
the subassemblies (16) are tilted to the horizontal position and fastened to a heavy goods vehicle.

9. A method according to claim 8, characterized in that the step for inserting the reformed guide tube for control cluster rods (4) into its packaging bottle (1) is carried out outside the pool, dry or underwater, using a heavy hood to remove the guide tube from the nuclear reactor.

10. The method according to claim 8, characterized in that the step for inserting the reformed guide tube for control cluster rods (4) into its packaging bottle (1) is carried out in the pool, i.e., underwater in the reactor, an additional operation for drying the bottles being provided.

11. The method according to claim 8, characterized in that the transfer of the fagot assembly (2) from the outside to the reactor building and vice versa is done using an equipment access hatch, the fagot assembly (2) being in a vertical or horizontal position for the transfer.
